(19) United States
(12) Patent Application Publication
(10) Pub. No.: US 2024/0262558 A1
(43) Pub. Date: Aug. 8, 2024

(54) PLASTIC CONTAINER WITH OXYGEN SCAVENGER AND PASSIVE OXYGEN BARRIER IN BODY PORTION

(71) Applicant: NIAGARA BOTTLING, LLC, Diamond Bar, CA (US)

(72) Inventor: Mohammadreza Nasiri, Brea, CA (US)

(21) Appl. No.: 18/562,081

(22) PCT Filed: Jun. 2, 2022
(86) PCT No.: PCT/US22/31914

§ 371 Date: Nov. 17, 2023

Related U.S. Application Data
(60) Provisional application No. 63/196,033, filed on Jun. 2, 2021.

(51) Int. Cl. B65D 1/02; B29C 45/00; B29C 49/00; B29C 49/06; B29C 49/22; B29K 67/00; B29K 105/16; B29L 31/00; B65D 81/26; C08L 67/02

(52) U.S. Cl. CPC B65D 1/0207; B29C 45/0001; B29C 49/0005; B65D 81/266; C08L 67/02; B29C 49/06; B29C 49/22; B29K 2067/003; B29K 2105/16; B29K 2995/0067; B29L 2031/712; B65D 2501/0036

(57) ABSTRACT

Described herein are containers and methods of manufacturing the same. In one embodiment, a container is disclosed that comprises a body portion comprising polyethylene terephthalate (PET) material, one or more oxygen scavengers interspersed within the PET material, and one or more passive oxygen barriers interspersed within the PET material. In another embodiment, a method of manufacturing a container is disclosed that comprises blending a PET resin with one or more oxygen scavengers and one or more passive oxygen barriers. In another embodiment, a method of manufacturing a container is disclosed that comprises injection molding multiple PET resin layers, wherein the multiple PET resin layers may comprise one or more oxygen scavengers, one or more passive oxygen barriers, or a combination thereof.

### CROSS-REFERENCE TO RELATED APPLICATIONS

The present application claims priority to U.S. provisional patent application No. 63/196,033, filed Jun. 2, 2021, the disclosure of which is hereby incorporated by reference in its entirety.

### FIELD OF DISCLOSURE

The present disclosure relates to materials, methods, and techniques for reducing the exposure of beverage products to free oxygen molecules. Exemplary implementations may include one or more oxygen scavengers and one or more passive oxygen barriers in a body portion of a plastic container. In various implementations, one or more oxygen scavengers and one or more passive oxygen barriers may be blended or layered during the manufacturing process of the plastic container.

### INTRODUCTION

The instant disclosure relates to beverage containers. A common plastic used in making beverage containers is polyethylene terephthalate (PET). The liquid contents stored within the interior of PET containers may react with free oxygen molecules that are present in the sealed environment. This can adversely affect concentration of the ingredients or produce undesirable off flavors in beverage products and reduce shelf life.

### SUMMARY

Materials, methods, and techniques disclosed and contemplated herein relate to containers and methods of manufacturing the same. The containers and methods disclosed herein may reduce the amount of oxygen that is able to react with beverage products in a sealed environment.

In one embodiment, a container is disclosed. The container comprises a body portion comprising PET material; one or more oxygen scavengers interspersed within the PET material; and one or more passive oxygen barriers interspersed within the PET material.

In another embodiment, a method of manufacturing a container is disclosed. The method comprises forming a PET resin; blending the PET resin with one or more oxygen scavengers and one or more passive oxygen barriers to form a mixture; injection molding the mixture to form a preform of a body portion of the container; and blow molding the preform of the body portion of the container to form the container.

In another embodiment, a method of manufacturing a container is disclosed. The method comprises forming a first PET resin layer; forming a second PET resin layer, the second PET resin layer comprising one or more oxygen scavengers, one or more passive oxygen barriers, or a combination thereof; injection molding the first PET resin layer and the second PET resin layer to form a preform of a body portion of the container; and blow molding the preform of the body portion of the container to form the container.

Other aspects of the disclosure will become apparent by consideration of the detailed description and accompanying drawings. There is no specific requirement that a material, method, or technique all of the details characterized herein, in order to obtain some benefit according to the present disclosure. Thus, the specific examples characterized are meant to be exemplary applications of the techniques described, and alternatives are possible.

### BRIEF DESCRIPTION OF THE DRAWINGS

FIG. 1 is an elevational view of an example container.

FIG. 2 is a flow diagram of an exemplary method for manufacturing a container.

Before any embodiments of the disclosure are explained in detail, it is to be understood that the disclosure is not limited in its application to the details of construction and the arrangement of components set forth in the following description or illustrated in the following drawings. Also, it is to be understood that the phraseology and terminology used herein is for the purpose of description and should not be regarded as limiting.

### DETAILED DESCRIPTION

Unless otherwise defined, all technical and scientific terms used herein have the same meaning as commonly understood by one of ordinary skill in the art. In case of conflict, the present disclosure, including definitions, will control.

As used herein, the terms such as “include,” “including,” “contain,” “containing,” “having,” and the like mean “comprising.” The present disclosure also contemplates other embodiments “comprising,” “consisting of,” and “consisting essentially of,” the embodiments or elements presented herein, whether explicitly set forth or not.

As used herein, the term “about” or “approximately” as applied to one or more values of interest, refers to a value that is similar to a stated reference value, or within an acceptable error range for the particular value as determined by one of ordinary skill in the art, which will depend in part on how the value is measured or determined, such as the limitations of the measurement system. In one aspect, the term “about” refers to any values, including both integers and fractional components that are within a variation of up to ±10% of the value modified by the term “about.” Alternatively, “about” can mean within 3 or more standard deviations, per the practice in the art.

All ranges disclosed herein include both end points as discrete values as well as all integers and fractions specified within the range. For example, a range of 0.1-2.0 includes 0.1, 0.2, 0.3, 0.4 . . . 2.0. If the end points are modified by the term “about,” the range specified is expanded by a variation of up to +10% of any value within the range or within 3 or more standard deviations, including the end points.

As used herein, the term “interspersed” refers to a substance being present between, among, or within another substance in a random or irregular manner. For instance, in one aspect of the present disclosure, one or more oxygen scavengers and one or more passive oxygen barriers may be interspersed within a PET material. In one aspect, the one or more oxygen scavengers and one or more passive oxygen barriers may be interspersed within the PET material using blending or mixing techniques.

As used herein, the term “sequentially” refers to separate operations that are performed in sequence, where a first operation is performed and is followed by one or more subsequent operations being performed. For instance, in one aspect of the present disclosure, multiple PET resin layers may be injection molded sequentially, where a first PET resin layer is injection molded and is followed by injection molding of a second PET resin layer to form a preform.

Materials, methods, and techniques disclosed and contemplated herein relate to passive oxygen barriers and oxygen scavengers in containers. More particularly, exemplary implementations may include one or more oxygen scavengers and one or more passive oxygen barriers in a body portion of a container. In various implementations, one or more oxygen scavengers and one or more passive oxygen barriers may be blended or layered during the manufacturing process of the container. Exemplary containers are typically suited for liquid contents.

Although blending PET with oxygen scavengers can protect oxygen-sensitive ingredients in hot fill and aseptic beverage products, resulting containers may have one or more undesirable aspects. For instance, blending PET with too high of concentrations of oxygen scavengers can result in lower grade, hazy-colored PET containers and can also encumber recycling with a clear PET stream. An alternative approach to oxygen scavengers is to use passive oxygen barriers. Passive oxygen barriers are materials that have the ability to block and prevent the ingress of oxygen through the walls of a container. However, the use of passive oxygen barriers alone will not eliminate the oxygen that is trapped in the head space of the container, such as during the container filling process or oxygen entering the sealed container through its closure.

The blending of PET with passive oxygen barriers allows for lower concentrations of oxygen scavengers while maintaining the protection of oxygen-sensitive ingredients in a container, without negatively affecting the recyclability of the container (e.g., the resulting recycled plastic grade, etc.). A combined use of passive oxygen barriers and oxygen scavengers with PET can reduce oxygen permeation into the container and beverage product through the container (e.g., a sidewall, a base, a bell, etc.). A combined use of passive oxygen barriers and oxygen scavengers with PET can also remove free oxygen molecules trapped in the beverage and head space of the container, as well as oxygen entering the sealed container through its closure.

### I. Example Oxygen Scavengers and Example Passive Oxygen Barriers

Exemplary containers include a blend of oxygen scavengers and passive oxygen barriers incorporated within a body portion of a container. More specifically, the oxygen scavengers and passive oxygen barriers may be blended with PET during, or prior to, the injection molding process for incorporation into the container materials. Exemplary aspects of oxygen scavengers and passive oxygen barriers are discussed below.

### A. Oxygen Scavengers

Exemplary oxygen scavengers are capable of reacting with free oxygen in an adjacent environment. In some instances, exemplary oxygen scavengers may eliminate most or all free oxygen in the environment. The reaction mechanism involves an oxygen scavenging agent, which acts as a reducing agent, becoming oxidized upon interaction with free oxygen molecules, thereby converting oxygen to a reduced and non-reactive species. Oxygen scavengers can include organic, metallic, inorganic, polymer-based, or enzyme-based agents, or combinations thereof.

Exemplary oxygen scavengers are capable of being incorporated into a body portion of a container by blending one or more oxygen scavengers with PET during the preform injection molding process.

Exemplary oxygen scavengers may be metallic. For instance, metallic oxygen scavengers may include one or more of iron powder, activated iron, ferrous oxide, iron salt, cobalt, copper, manganese, or zinc.

Exemplary oxygen scavengers may be organic. Exemplary organic oxygen scavengers may include one or more of ascorbic acid, ascorbic acid salts, isoascorbic acid, tocopherol (vitamins C and E), hydroquinone, catechol, rongalit, sorbose, lignin, gallic acid, or polyunsaturated fatty acids.

Exemplary oxygen scavengers may be inorganic. Exemplary inorganic oxygen scavengers may include one or more of sulfite, thiosulfate, dithionite, hydrogen sulfite, or titanium dioxide.

Exemplary oxygen scavengers may be polymer-based. Exemplary polymer-based oxygen scavengers may include one or more of oxidation-reduction resins or polymer-metallic complexes.

Exemplary oxygen scavengers may be enzyme-based. Exemplary enzyme-based oxygen scavengers may include one or more of glucose oxidase, laccase, or ethanol oxidase.

Commercially available examples of oxygen scavengers suitable for PET include OxyClear®, available from Indorama Ventures (Bangkok, Thailand) and Colormatrix Amosorb™ 4020G, Colormatrix Amosorb™ 4020R, and Colormatrix Amosorb™ 100, available from Avient (Avon Lake, Ohio).

### B. Passive Oxygen Barriers

Exemplary passive oxygen barriers are capable of blocking the ingress of free oxygen into an adjacent environment. Passive oxygen barriers can block oxygen by forming tight molecular blocks that prevent permeation of oxygen and other gases. In the context of beverage containers, passive oxygen barriers can prevent migration of oxygen molecules from outside of the beverage container across the plastic sidewall and into the interior of the beverage container.

Exemplary passive oxygen barriers are capable of being incorporated into a body portion of a container by blending one or more passive oxygen barriers with PET during the preform injection molding process. Exemplary passive oxygen barriers may be co-injected as one or more separate layers with the container sidewalls.

Exemplary passive oxygen barriers may include polyamides produced from m-xylylenediamine (MXDA), including nylon-MXD6. Other exemplary passive oxygen barriers may include one or more polymers including polyethylene furanoate (PEF), polyethylene naphthalate (PEN), polyglycolic acid (PGA), polyamide-6 (PA6), polyvinyl alcohol (PVOH), ethylene vinyl alcohol (EVOH), or polyvinylidene chloride (PVDC).

### II. Example Containers

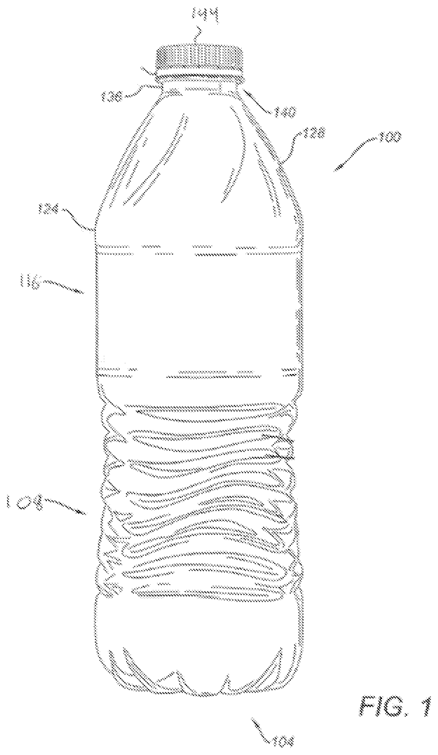

FIG. 1 illustrates an elevational view of an example of an embodiment of a container 100. The container 100 may be used for storing liquid contents, such as a beverage for consumption (e.g., water, juice, a carbonated beverage, a noncarbonated beverage, tea, coffee, sports drink, etc.). The container 100 includes a base 104 that extends to a sidewall 108. In some embodiments, the base 104 may include various geometries defined by a plurality of radial recesses, although other configurations of the base 104 may be incorporated into the container 100, without limitation. The sidewall 108 can include a label panel portion 116. The sidewall 108 transitions into a shoulder 124, which connects to a bell 128.

The bell 128 connects to a neck 136, which defines a finish portion 140. As shown in FIG. 1, the bell 128 includes a diameter that generally decreases along the bell 128 from the shoulder 124 to the neck 136. The finish portion 140 can include a helical bead (not shown) that is configured to selectively engage a closure 144 (e.g., a container cap, etc.). More specifically, the helical bead can engage a corresponding helical groove defined by an interior of the closure 144 to seal the beverage within the container 100. The neck 136 and finish portion 140 generally define an opening that leads to an interior of the container 100. The opening provides selective access to the contents of the container 100, with the closure 144 selectively sealing the opening.

In some embodiments, the container 100 may also include one or more passive oxygen barriers and one or more oxygen scavengers. Passive oxygen barriers and/or oxygen scavengers may be included as layers or as a blended combination with the plastic material of the container 100.

Typically, passive oxygen barriers and oxygen scavengers are included in a body portion of container 100. Generally, a body portion of container 100 includes base 104, sidewall 108, shoulder 124, bell 128, and neck 136. Generally, a body portion of container 100 does not include a finish portion 140 or a closure 144.

In some instances, passive oxygen barriers and oxygen scavengers are included only in sidewall 108. In some instances, passive oxygen barriers and oxygen scavengers may be included in sidewall 108 and one or more of shoulder 124, the bell 128, and/or the neck 136. In some instances, passive oxygen barriers and oxygen scavengers may be included in sidewall 108 and one or more of the base 104, shoulder 124, the bell 128, and/or the neck 136.

In some embodiments, one or more passive oxygen barriers may be present at up to about 25% by weight (wt. %) of the total PET material used to construct the body portion of container 100. In various implementations, one or more passive oxygen barriers may be present at up to 25 wt %; up to 20 wt %; up to 15 wt % up to 10 wt %; up to 5 wt %; or up to 2.5 wt % of the total PET material used to construct the body portion of container 100. In various implementations, one or more passive oxygen barriers may be present at no less than 2.5 wt %; no less than 5 wt %; no less than 10 wt %; no less than 15 wt %; or no less than 20 wt % of the total PET material used to construct the body portion of container 100. In various implementations, one or more passive oxygen barriers may be present at 2.5-25 wt %; 5-25 wt %; 10-25 wt %; 2.5-15 wt %; 2.5-10 wt %; 5-15 wt %; or 20-25 wt % of the total PET material used to construct the body portion of container 100.

In some embodiments, one or more oxygen scavengers may be present at up to about 5 wt. % of the total PET material used to construct the body portion of container 100. In various implementations, one or more oxygen scavengers may be present at up to 5.0 wt %; up to 4.5 wt %; up to 4.0 wt %; up to 3.5 wt %; up to 3.0 wt %; up to 2.5 wt %; up to 2.0 wt %; up to 1.5 wt %; up to 1.0 wt %; up to 0.5 wt %; up to 0.25 wt %; or up to 0.1 wt % of the total PET material used to construct the body portion of container 100. In various implementations, one or more oxygen scavengers may be present at no less than 0.1 wt %; no less than 0.25 wt %; no less than 0.5 wt %; no less than 1.0 wt %; no less than 1.5 wt %; no less than 2.0 wt %; no less than 2.5 wt %; no less than 3.0 wt %; no less than 3.5 wt %; no less than 4.0 wt %; or no less than 4.5 wt % of the total PET material used to construct the body portion of container 100. In various implementations, one or more oxygen scavengers may be present at 0.1-5 wt %; 0.1-2.5 wt %; 2.5-5.0 wt %; 1.0-4.0 wt %, or 2.0-3.0 wt % of the total PET material used to construct the body portion of container 100.

### III. Example Methods of Manufacture

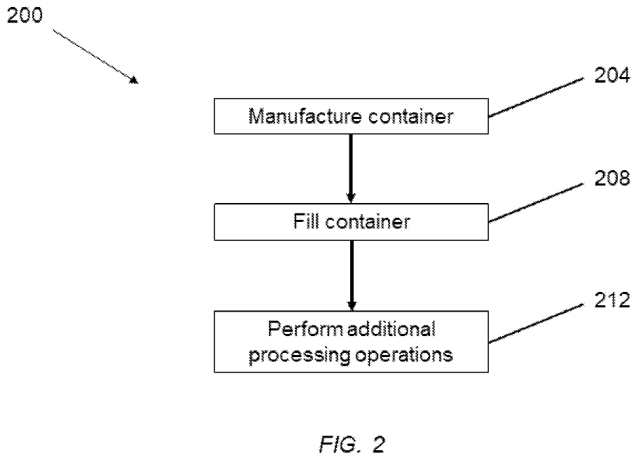

FIG. 2 is an example process 200 for manufacturing a container 100. The process 200 begins at operation 204, where the container 100 is manufactured. For example, the container 100 may be blow molded from a preform using a blow molding process. In other embodiments, the container 100 may be molded in any generally known or desired process for producing the container 100.

In some embodiments, the container 100 may be manufactured from a PET resin that is blended with a combination of one or more passive oxygen barriers and one or more oxygen scavengers. For example, the PET resin may be blended with a mixture of passive oxygen barriers and oxygen scavengers during, or prior to, injection molding to create a blended preform that includes passive oxygen barriers and oxygen scavengers interspersed within the PET. The preform may then be blow molded to generate the container 100 as described above.

In some embodiments, the container 100 may be manufactured from a multi-layered preform that is formed by co-injection molding two or more separate layers of PET, where each of the two or more separate layers of PET may include one or more passive oxygen barriers, one or more oxygen scavengers, or a combination thereof interspersed within the PET. In one aspect, the two or more separate layers of PET may be injection molded simultaneously. In another aspect, the two or more separate layers of PET may be injection molded sequentially. For example, the preform may be formed by injecting a PET layer, followed by injection of a separate PET layer including one or more passive oxygen barriers and one or more oxygen scavengers, followed by injection of another separate PET layer. In another example, separate PET layers may be co-injected simultaneously with a PET layer including one or more passive oxygen barriers and one or more oxygen scavengers to form the multi-layered preform. The multi-layered preform may then be blow molded to generate the container 100 as described above.

In some embodiments, the container 100 may be manufactured from a multi-layered preform that is formed by injection molding a PET layer with or without oxygen scavengers, followed by injection of a separate PET layer including one or more passive oxygen barriers with or without one or more oxygen scavengers, followed by injection of another separate PET layer with or without one or more oxygen scavengers. For example, the multi-layered preform may be injected as a PET layer, followed by injection of a separate PET layer including one or more oxygen scavengers, followed by injection of another separate PET layer. In another example, the multi-layered preform may be injected as a PET layer including one or more oxygen scavengers, followed by injection of a separate PET layer including one or more passive oxygen barriers with or without one or more oxygen scavengers, followed by injection of another separate PET layer including one or more oxygen scavengers. The multi-layered preform may then be blow molded to generate the container 100 as described above.

At operation 208, the container 100 may be filled with a liquid (or a beverage). The filling of the container 100 can include filling (e.g., aseptic, non-aseptic, etc.). After filling, the container 100 may be capped through application of the closure 144. In other operations, the container 100 may be disinfected prior to filling of the container 100 (e.g., aseptic) or after filling of the container 100 (e.g., non-aseptic). The container 100 exits operation 208 with the liquid in the container 100 and the removable closure 144 attached, sealing the opening, and the associated liquid within the container 100.

At operation 212, the container 100 proceeds to any additional processing operations that can include application of a label, sorting, packaging (e.g., shrink wrap application in cases, application of a handle, etc.), palletizing, etc.

It is understood that the foregoing detailed description and accompanying examples are merely illustrative and are not to be taken as limitations upon the scope of the disclosure. Various changes and modifications to the disclosed embodiments will be apparent to those skilled in the art. Such changes and modifications, including without limitation those relating to the chemical structures, substituents, derivatives, intermediates, syntheses, compositions, formulations, or methods of use, may be made without departing from the spirit and scope of the disclosure.

Various aspects of the disclosure are set out in the following numbered embodiments:

Embodiment 1. A container, comprising:
a body portion comprising:
   polyethylene terephthalate (PET) material;
   one or more oxygen scavengers interspersed within the PET material; and
   one or more passive oxygen barriers interspersed within the PET material.

Embodiment 2. The container according to embodiment 1, wherein the body portion comprises a sidewall, the sidewall comprising the one or more oxygen scavengers and the one or more passive oxygen barriers interspersed within the PET material.

Embodiment 3. The container according to embodiment 1 or 2, wherein the one or more oxygen scavengers comprise an organic agent, a metallic agent, an inorganic agent, a polymer-based agent, an enzyme-based agent, or combinations thereof.

Embodiment 4. The container according to any one of embodiments 1-3, wherein the one or more oxygen scavengers are present at about 0.1 wt % to about 5.0 wt % of the PET material used to construct the body portion of the container.

Embodiment 5. The container according to any one of embodiments 1-4, wherein the one or more passive oxygen barriers comprise nylon-MXD6, polyethylene furanoate (PEF), polyethylene naphthalate (PEN), polyglycolic acid (PGA), polyamide-6 (PA6), polyvinyl alcohol (PVOH), ethylene vinyl alcohol (EVOH), polyvinylidene chloride (PVDC), or combinations thereof.

Embodiment 6. The container according to any one of embodiments 1-5, wherein the one or more passive oxygen barriers are present at about 2.5 wt % to about 25 wt % of the PET material used to construct the body portion of the container.

Embodiment 7. The container according to any one of embodiments 1-6, wherein the body portion further comprises one or more of a base, a shoulder, a bell, or a neck, wherein the one or more oxygen scavengers and the one or more passive oxygen barriers are interspersed within the PET material of one or more of the base, the shoulder, the bell, or the neck.

Embodiment 8. A method of manufacturing a container, the method comprising:
forming a polyethylene terephthalate (PET) resin;
blending the PET resin with one or more oxygen scavengers and one or more passive oxygen barriers to form a mixture;
injection molding the mixture to form a preform of a body portion of the container; and
blow molding the preform of the body portion of the container to form the container.

Embodiment 9. The method according to embodiment 8, wherein blending the PET resin with the one or more oxygen scavengers and the one or more passive oxygen barriers to form the mixture is performed during injection molding.

Embodiment 10. The method according to embodiment 8, wherein blending the PET resin with the one or more oxygen scavengers and the one or more passive oxygen barriers to form the mixture is performed prior to injection molding.

Embodiment 11. The method according to any one of embodiments 8-10, wherein the one or more oxygen scavengers comprise an organic agent, a metallic agent, an inorganic agent, a polymer-based agent, an enzyme-based agent, or combinations thereof.

Embodiment 12. The method according to any one of embodiments 8-11, wherein the one or more passive oxygen barriers comprise nylon-MXD6, polyethylene furanoate (PEF), polyethylene naphthalate (PEN), polyglycolic acid (PGA), polyamide-6 (PA6), polyvinyl alcohol (PVOH), ethylene vinyl alcohol (EVOH), polyvinylidene chloride (PVDC), or combinations thereof.

Embodiment 13. The method according to any one of embodiments 8-12, wherein the body portion of the container comprises a sidewall, a base, a shoulder, a bell, a neck, or combinations thereof, and wherein the one or more oxygen scavengers and the one or more passive oxygen barriers are interspersed within a PET material of one or more of the sidewall, the base, the shoulder, the bell, or the neck.

Embodiment 14. A method of manufacturing a container, the method comprising:
forming a first polyethylene terephthalate (PET) resin layer;
forming a second PET resin layer, the second PET resin layer comprising one or more oxygen scavengers, one or more passive oxygen barriers, or a combination thereof;
injection molding the first PET resin layer and the second PET resin layer to form a preform of a body portion of the container; and
blow molding the preform of the body portion of the container to form the container.

Embodiment 15. The method according to embodiment 14, wherein the first PET resin layer and the second PET resin layer are injection molded simultaneously.

Embodiment 16. The method according to embodiment 14, wherein the first PET resin layer and the second PET resin layer are injection molded sequentially.

Embodiment 17. The method according to any one of embodiments 14-16, wherein the first PET resin layer comprises one or more oxygen scavengers, one or more passive oxygen barriers, or a combination thereof.

Embodiment 18. The method according to any one of embodiments 14-17, further comprising forming one or more additional PET resin layers, and injection molding the one or more additional PET resin layers with the first PET resin layer and the second PET resin layer to form the preform of the body portion of the container.

Embodiment 19. The method according to any one of embodiments 14-18, wherein the one or more additional PET resin layers comprise one or more oxygen scavengers, one or more passive oxygen barriers, or a combination thereof.

Embodiment 20. The method according to any one of embodiments 14-19, wherein the body portion of the container comprises a sidewall, a base, a shoulder, a bell, a neck, or combinations thereof, and wherein the one or more oxygen scavengers and the one or more passive oxygen barriers are interspersed within a PET material of one or more of the sidewall, the base, the shoulder, the bell, or the neck.

What is claimed is:

1. A container, comprising:
a body portion comprising:
polyethylene terephthalate (PET) material;
one or more oxygen scavengers interspersed within the PET material; and
one or more passive oxygen barriers interspersed within the PET material.

2. The container according to claim 1, wherein the body portion comprises a sidewall, the sidewall comprising the one or more oxygen scavengers and the one or more passive oxygen barriers interspersed within the PET material.

3. The container according to claim 1, wherein the one or more oxygen scavengers comprise an organic agent, a metallic agent, an inorganic agent, a polymer-based agent, an enzyme-based agent, or combinations thereof.

4. The container according to claim 3, wherein the one or more oxygen scavengers are present at about 0.1 wt % to about 5.0 wt % of the PET material used to construct the body portion of the container.

5. The container according to claim 1, wherein the one or more passive oxygen barriers comprise nylon-MXD6, polyethylene furanoate (PEF), polyethylene naphthalate (PEN), polyglycolic acid (PGA), polyamide-6 (PA6), polyvinyl alcohol (PVOH), ethylene vinyl alcohol (EVOH), polyvinylidene chloride (PVDC), or combinations thereof.

6. The container according to claim 5, wherein the one or more passive oxygen barriers are present at about 2.5 wt % to about 25 wt % of the PET material used to construct the body portion of the container.

7. The container according to claim 1, wherein the body portion further comprises one or more of a base, a shoulder, a bell, or a neck, wherein the one or more oxygen scavengers and the one or more passive oxygen barriers are interspersed within the PET material of one or more of the base, the shoulder, the bell, or the neck.

8. A method of manufacturing a container, the method comprising:
forming a polyethylene terephthalate (PET) resin;
blending the PET resin with one or more oxygen scavengers and one or more passive oxygen barriers to form a mixture;
injection molding the mixture to form a preform of a body portion of the container; and
blow molding the preform of the body portion of the container to form the container.

9. The method according to claim 8, wherein blending the PET resin with the one or more oxygen scavengers and the one or more passive oxygen barriers to form the mixture is performed during injection molding.

10. The method according to claim 8, wherein blending the PET resin with the one or more oxygen scavengers and the one or more passive oxygen barriers to form the mixture is performed prior to injection molding.

11. The method according to claim 8, wherein the one or more oxygen scavengers comprise an organic agent, a metallic agent, an inorganic agent, a polymer-based agent, an enzyme-based agent, or combinations thereof.

12. The method according to claim 8, wherein the one or more passive oxygen barriers comprise nylon-MXD6, polyethylene furanoate (PEF), polyethylene naphthalate (PEN), polyglycolic acid (PGA), polyamide-6 (PA6), polyvinyl alcohol (PVOH), ethylene vinyl alcohol (EVOH), polyvinylidene chloride (PVDC), or combinations thereof.

13. The method according to claim 8, wherein the body portion of the container comprises a sidewall, a base, a shoulder, a bell, a neck, or combinations thereof, and wherein the one or more oxygen scavengers and the one or more passive oxygen barriers are interspersed within a PET material of one or more of the sidewall, the base, the shoulder, the bell, or the neck.

14. A method of manufacturing a container, the method comprising:
forming a first polyethylene terephthalate (PET) resin layer;
forming a second PET resin layer, the second PET resin layer comprising one or more oxygen scavengers, one or more passive oxygen barriers, or a combination thereof;
injection molding the first PET resin layer and the second PET resin layer to form a preform of a body portion of the container; and
blow molding the preform of the body portion of the container to form the container.

15. The method according to claim 14, wherein the first PET resin layer and the second PET resin layer are injection molded simultaneously.

16. The method according to claim 14, wherein the first PET resin layer and the second PET resin layer are injection molded sequentially.

17. The method according to claim 14, wherein the first PET resin layer comprises one or more oxygen scavengers, one or more passive oxygen barriers, or a combination thereof.

18. The method according to claim 14, further comprising forming one or more additional PET resin layers, and injection molding the one or more additional PET resin layers with the first PET resin layer and the second PET resin layer to form the preform of the body portion of the container.

19. The method according to claim 18, wherein the one or more additional PET resin layers comprise one or more oxygen scavengers, one or more passive oxygen barriers, or a combination thereof.

20. The method according to claim 14, wherein the body portion of the container comprises a sidewall, a base, a shoulder, a bell, a neck, or combinations thereof, and wherein the one or more oxygen scavengers and the one or more passive oxygen barriers are interspersed within a PET material of one or more of the sidewall, the base, the shoulder, the bell, or the neck.
